(19) United States
(12) Patent Application Publication
(10) Pub. No.: US 2011/0115867 A1
(43) Pub. Date: May 19, 2011

(54) SUCTION CUPS FOR INK-BASED PRINTERS

(76) Inventors: Peter Forgacs, Givon HaHadasha (IL); Neta Filip-Granit, Moshav azikarn (IL); Stella Stolin Roditi, Rehovot (IL); David Levanon, Rishon Le Zion (IL); Liat Szapiro, Moshav Gsaita (IL); Yossi Mor, Omer (IL); Mark Sandler, Rehovot (IL); Itzhak Ashkenazi, Kfar Gibton (IL); Meir Soria, Jerusalem (IL); Marc Klein, Tel Aviv (IL)

(21) Appl. No.: 13/054,005

(22) PCT Filed: Jul. 17, 2008
(86) PCT No.: PCT/US08/70283

§ 371 Date: Jan. 13, 2011

(51) Int. Cl. B41J 2/01

(52) U.S. Cl. 347/104

(57) ABSTRACT

A suction cup for a printer includes a cup portion that includes a contact surface adapted to contact print media within the printer, the contact surface being formed by a low surface energy material. In some embodiments, the contact surface is rough.

### BACKGROUND

Ink-based printers sometimes use suction cups to move print media, such as paper, within the printer. Unfortunately, suction cups can leave marks on the printed media. Specifically, outlines of the suction cups, referred to in the industry as suction cup marks, may appear on printed images, thereby significantly reducing print quality.

### BRIEF DESCRIPTION OF THE DRAWINGS

The disclosed suction cups can be better understood with reference to the following drawings. The components in the drawings are not necessarily to scale.

FIG. 1 is a perspective view of an embodiment of a suction cup configured to reduce adhesion of ink to the suction cup.

FIG. 2 is a partial side view of a first embodiment of a cup portion of the suction cup shown in FIG. 1.

FIG. 3 is a partial side view of a second embodiment of a cup portion of the suction cup shown in FIG. 1.

FIG. 4 is a partial side view of a third embodiment of a cup portion of the suction cup shown in FIG. 1.

FIG. 5 is a partial side view of a fourth embodiment of a cup portion of the suction cup shown in FIG. 1.

FIG. 6 is a partial side view of a fifth embodiment of a cup portion of the suction cup shown in FIG. 1.

### DETAILED DESCRIPTION

As described above, suction cups used in ink-based printers can leave marks on printed media. As described below, the frequency and/or severity of such suction cup marks can be reduced using suction cups comprising a surface formed from a low surface energy material.

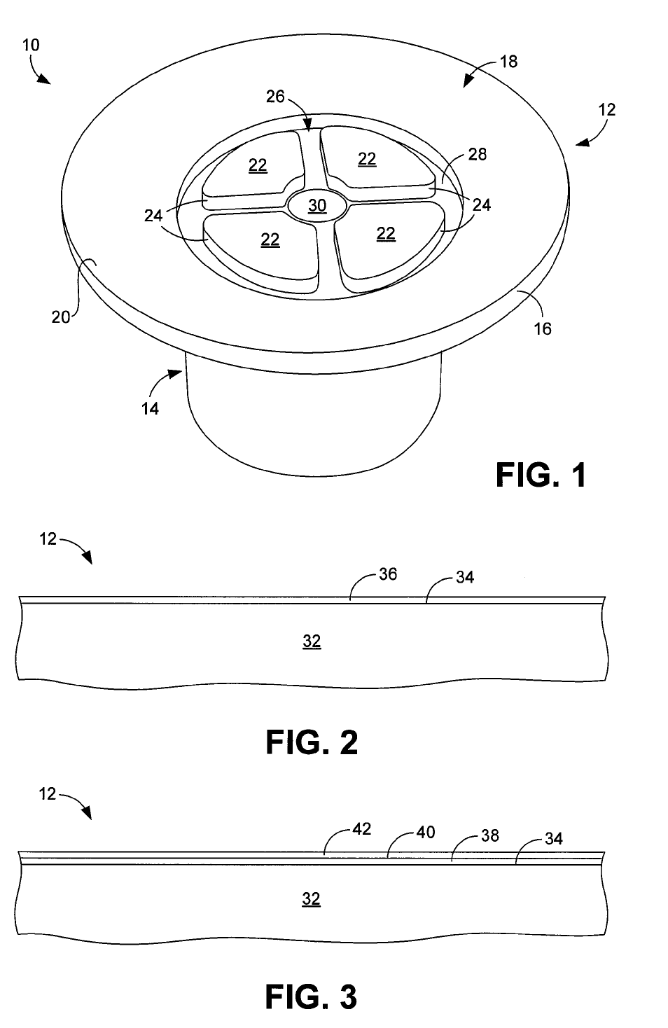

Referring to the figures, in which like numerals identify corresponding parts, illustrated in FIG. 1 is a suction cup 10 for use in an ink-based printer. As indicated in FIG. 1, the suction cup 10 comprises a body that includes a cup portion 12 and a neck portion 14 that extends from the cup portion. In some embodiments, the cup portion 12 and neck portion 14 are unitarily formed from the same material. Such a result can be achieved using, for example, an injection molding process. As described below, at least the cup portion 12 is constructed of a flexible material, such as an elastomeric material.

The cup portion 12 comprises a generally circular outer periphery 16 and a contact surface 18 adapted to be placed in contact with print media within a printer. In the embodiment illustrated in FIG. 1, the contact surface 18 includes an outer circular surface 20 and the top surfaces 22 of central elements 24. The central elements 24 are defined by an X-shaped channel 26 provided within the center of the cup portion 12 and a circular channel 28 that surrounds the X-shaped channel. Accordingly, the central elements 24 are generally wedge-shaped, each generally forming a quadrant of a complete circle.

Formed in the center of the X-shaped channel 26 is a central opening 30 that extends through the neck portion 14. When the suction cup 10 is attached to a vacuum source, such as a pneumatic pump, the opening 30 can be used together with the channels 26, 28 to draw print media into firm contact with the contact surface 18.

As mentioned above, suction cups, such as those similar to the suction cup 10 of FIG. 1, can leave marks on printed media. Although such marks can be caused by mechanical deformation or “imprint” of the ink due to contact with the suction cups, suction cup marks are often the result of the ink sticking to the suction cups. The phenomenon in which ink sticks to the suction cup, and therefore transfers onto the suction cup, is referred to in the industry as “offset.”

Offset occurs when the ink, and more particularly the liquid carrier within the ink, “wets” the surface of the suction cup. As known in the physical sciences, “wetting” is a term that describes the extent to which a liquid spreads across a surface. That extent is often quantified by the contact angle, which is the angle the outer surface of a bead of liquid forms with a surface. The greater the contact angle, the less the liquid wets the surface. The amount of wetting that results for a liquid on a surface is related to intermolecular interactions between the liquid and the surface and, more particularly, the energies of the interface between the liquid and the surface.

As can be appreciated from the above, if the degree with which the ink wets the suction cup 10 is reduced, the tendency of the ink to stick to the suction cup can likewise be reduced. As described in the following, reduced wetting is achieved by using a low surface energy material to form the contact surface 18 of the suction cup 10. When such a material is used, the suction cup 10 repels the ink such that the contact angle is reduced and the ink will not easily spread across the contact surface 18. As used herein, the term “low surface energy material” is any material that has a surface energy less than approximately 25 milli-Newtons per meter (mN/m) as characterized by contact angle measurements employing one or multiple probe liquids, such as water, diiodo-methane, and glycerin. In some embodiments, the low surface energy material that is used to form the contact surface 18 of the suction cup 10 comprises a fluoroelastomer, fluorosilicone, or silicone.

In some cases, the entire suction cup 10 is constructed of the low surface energy material. For example, the cup portion 12 and neck portion 14 can be formed by injecting the selected low surface energy material into a mold. In other cases, the cup portion 12 comprises an outer layer of low surface energy material. In such a case, the cup portion 12 and neck portion 14 can be formed from a suitable elastomeric material, such as nitrile rubber, and the selected low surface energy material can then be applied to the cup portion using a suitable process, such as a spray coating or a clip coating process. Such an embodiment is depicted in FIG. 2. As shown in that figure, the cup portion 12 comprises a body 32 that includes an outer surface 34 to which is applied a low surface energy material coating 36. By way of example, the coating 36 is approximately 5 to 20 microns (μm)) thick.

FIG. 3 illustrates an alternative embodiment in which a low surface energy material has been applied to the cup portion 12. As indicated in that figure, a low surface energy material coating 42 has been applied to an outer surface 40 of a binder coating 38, which has been directly applied to the cup portion body 32 to improve adhesion of the low surface energy material to the cup portion 12. By way of example, the binder coating 38 comprises a siloxane-based primer that has been diluted in isopropyl alcohol and the low surface energy material coating 42 comprises a fluoroelastomer comprising activated silicon groups diluted in ethyl nonafluoroisobutyl ether. By further way of example, the hinder coating 38 is approximately 1 to 10 μm thick and the low surface energy material coating 42 is approximately 5 to 20 μm thick.

While use of a low surface energy material can significantly reduce wetting of a suction cup used in a printer, it can potentially result in sticking of unprinted print media to the suction cup. Specifically, low surface energy materials can cause unprinted paper to “wet” the suction cup such that the paper is less likely to release from the suction cup when desired. It has been determined that undesired adhesion of print media to suction cups can be achieved by increasing the roughness of the cup's contact surface. Notably, the increased roughness may, in some cases, further reduce suction cup mark visibility.

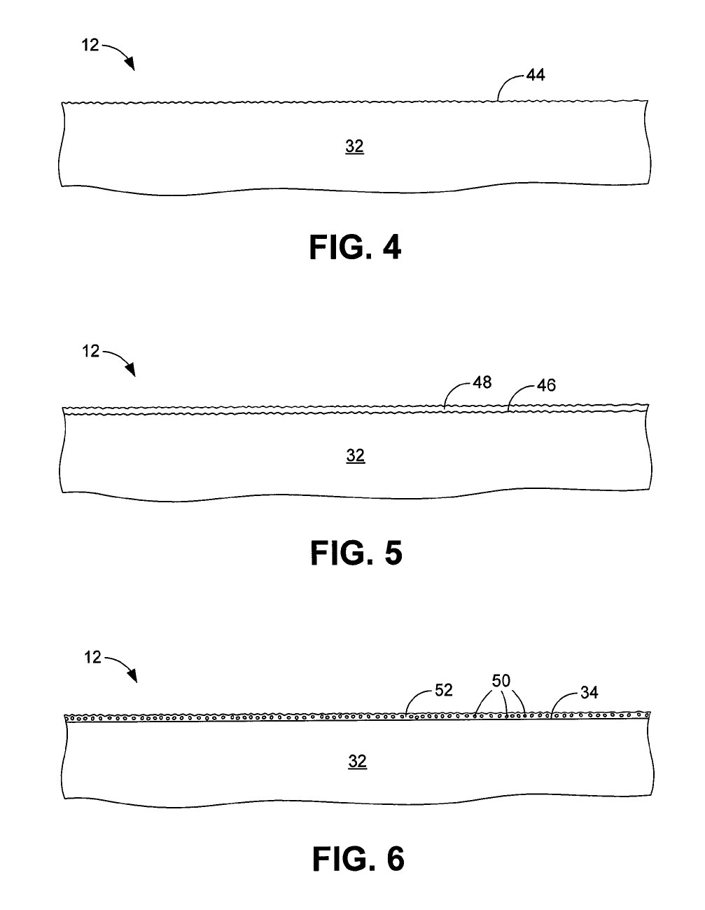

A rough contact surface can be created in several ways. In some embodiments, the roughness is created using a mold having an uneven inner surface that forms the contact surface of the suction cup. A first example of such injection molding is illustrated in FIG. 4, in which a cup portion 12 having a rough outer surface 44 has been formed using a low surface energy material as bulk material. A second example is illustrated in FIG. 5, in which the cup portion 12 having a rough outer surface 46 has been injection molded using a material other than a low surface energy material, and a low surface energy material 48 has been applied over the rough outer surface.

In other embodiments, the rough surface can be formed after the suction cup has been constructed. For example, as shown in FIG. 6 the roughness can be created by depositing small roughness elements 50 on the outer surface 34 of the cup portion body 32 prior to application of a low surface energy material 52. By way of example, the roughness elements comprise polytetrafluoroethylene, polyethylene, or silica. Notably, similar results to those shown in FIG. 6 can be achieved when the roughness elements 50 are mixed in with the low surface energy material 52 prior to its application to the cup portion body 32. In another example, a low surface energy material having a high viscosity can be used such that the low surface energy material will not self-level after being applied to the cup portion 12. In a further example, a low surface energy material that comprises gas bubbles can be used to yield a bumpy outer surface. As can be appreciated from FIGS. 4-6, irrespective of how the roughness is achieved, the contact surface forms protrusions that extend out from the contact surface. In some embodiments, the contact surface has an average roughness (Ra) of approximately 0.5 to 50 μm.

Although specific embodiments have been described above, it is to be understood that alternative embodiments are possible and are intended to fall within the scope of this disclosure. In some cases, one or more of the described embodiments can be combined. For example, the rough surface embodiments described in relation to FIGS. 5 and 6 could include a binding coating as the embodiment described in relation to FIG. 3.

Claimed are:

1. A suction cup for a printer, the suction cup comprising:
a cup portion that includes a contact surface adapted to contact print media within the printer, the contact surface being formed by a low surface energy material.

2. The suction cup of claim 1, wherein the low surface energy material comprises a fluoroelastomer, fluorosilicone, or silicone.

3. The suction cup of claim 1, wherein the entire cup portion is composed of the low surface energy material.

4. The suction cup of claim 1, wherein low surface energy material is a low surface energy material coating that has been applied to the cup portion.

5. The suction cup of claim 4, further comprising a binder coating that has been directly applied to a body of the cup portion and wherein the low surface energy material coating has been directly applied to the binder coating.

6. The suction cup of claim 1, wherein the contact surface is rough.

7. The suction cup of claim 6, wherein the contact surface comprises an average roughness (Ra) of approximately 0.5 to 50 microns.

8. The suction cup of claim 6, wherein the entire cup portion is composed of the low surface energy material.

9. The suction cup of claim 6, wherein the cup portion comprises a body having a rough outer surface to which a low surface energy material coating has been applied.

10. The suction cup of claim 6, wherein the low surface energy material is a coating that encompasses roughness elements that provide the roughness to the contact surface.

11. The suction cup of claim 10, wherein the roughness elements are composed of polytetrafluoroethylene, polyethylene, or silica.

12. A suction cup for a printer, the suction cup comprising:
a neck portion;
a cup portion connected to the neck portion that includes a rough contact surface adapted to contact print media within the printer, the contact surface being formed by a low surface energy material; and
an opening that extends through the neck and cup portions through which air can flow.

13. The suction cup of claim 12, wherein the low surface energy material comprises a fluoroelastomer, fluorosilicone, or silicone.

14. The suction cup of claim 12, wherein the low surface energy material is a coating that has been applied to the cup portion.

15. The suction cup of claim 12, wherein the entire cup portion is composed of the low surface energy material.
